(19) United States
(12) Patent Application Publication
(10) Pub. No.: US 2007/0170110 A1
(43) Pub. Date: Jul. 26, 2007

(54) FILTRATION DEVICE FOR REPLACEABLE FILTER MEDIA

(75) Inventors: Seiichi Onoue, Tokyo (JP); Takeshi Sakamaki, Yokohama (JP); Hiroshi Sagawa, Kagawa-cho (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/693,796

(22) Filed: Mar. 30, 2007

Related U.S. Application Data
(63) Continuation of application No. 10/798,133, filed on Mar. 10, 2004.
(60) Provisional application No. 60/453,415, filed on Mar. 10, 2003.

(51) Int. Cl. B01D 35/00

(52) U.S. Cl. 210/444

(57) ABSTRACT

Improved filter housing assembly including a filter housing sump assembly for seating a replaceable filter media pack therein, a filter head assembly and a fastening assembly for sealing and facilitating filter media pack replacement from the filter housing sump assembly and apparatus the filter housing sump having a central cavity and an axial opening for providing access to the central cavity, the central cavity being configured and dimensioned for receiving and seating a filter media pack therein; a filter head assembly configured and dimensioned to fit on the filter housing sump such that axial opening is covered thereby; a clamping device for sealing the filter head to the filter housing sump, the clamping device including at least two curved members, each having two ends; at least one hinge assembly, the pair of curved members being operatively pivotally attached to each other at one end by the hinge assembly; at least two tongue members, operatively positioned at the second end of the pair of curved members; and a fastening device, the fastening device being operative to force the tongues members together such that an operator can generate sufficient torque to effectuate the seal therebetween, for facilitating the installation of the filter media pack in the filter housing sump.

### RELATED APPLICATIONS

This application is a continuation of U.S. patent application Ser. No. 10/798133, filed Mar. 10, 2004, of Onoue et al, entitled “Filtration Device for Replaceable Filter Media,” and is a continuation-in-part of commonly owned U.S. Provisional Patent Application No. 60/453415, filed Mar. 10, 2003, the disclosure of which is herein incorporated by reference to the extent not inconsistent with the present disclosure.

### BACKGROUND OF THE DISCLOSURE

The subject disclosure relates to fluid filtration devices, and more particularly, to a filtration device that includes a filter housing sump assembly for seating a replaceable filter media pack therein, a filter head assembly and a fastening assembly for sealing and facilitating filter media pack replacement from the filter housing sump assembly.

Often in both consumer and industrial applications a fluid, such as water, is filtered prior to its use in an intended application. As a result, filtration systems are installed either internally or externally within the industrial system or consumer appliance.

These filtration systems generally include one or more filtration devices. In many of these systems, the filtration devices are of the type which includes a filter housing sump for seating a replaceable filter media pack therein, a filter head assembly with an inlet conduit for receiving untreated fluid and an outlet conduit for providing treated fluid, and a fastening assembly for securing the filter housing sump to the filter head assembly.

Filtration systems having filter head assembles which employ permanent filter housing sumps and replaceable filter cartridges are well known in the art and have been employed for many years to filter contaminated fluids. An early example of this type of system is disclosed in U.S. Pat. No. 2,858,026 to Lorimer. In such a system, the filter housing sump serves both as a pressure vessel to support the filter cartridge and a sump or bowl to receive contaminated fluid to be filtered. Consequently, when the filter cartridge is removed from the filter housing sump after a period of prolonged use, the housing sump remains contaminated. Therefore, the housing sump may need to be cleaned before installing a new filter cartridge. This is especially true for applications where different fluids will be filtered through the same filter housing system, i.e. various colored paints or pharmaceutical applications where cleaning between batches is necessary to insure no batch to batch contamination.

Those skilled in the art soon recognized the need to maintain the cleanliness of the filter housing sump and provided practical solutions to the problem, as disclosed, for example, in U.S. Pat. No. 3,684,100 to Close. The Close patent describes a system that includes a disposable filter cartridge consisting of a filter element encapsulated within a thin plastic shell and a metal housing that serves solely as a pressure vessel to support the filter cartridge. In use, contaminated fluid only flows though the filter cartridge, and the metal housing remains dry and clean.

For these devices, the frequent replacement of the filter media pack is required to sustain the proper filtration and quality of the output flow. Therefore, the fastening assembly must secure the filtration system to prevent leakage while also allowing for periodic access to the interior of the filter housing sump to facilitate filter media pack replacement and general maintenance to the device.

The fastening assemblies currently in use, such as bolt and nut tightening assemblies, may only be opened and closed with tools and may require compression of the parts for reinstallation. Furthermore, the filter head assembly must be taken off-line in order to replace the filter. This makes changing the filter media pack or performing maintenance on the filtration device difficult and time-consuming, even for a trained technician. The task may sometimes require an additional technician to complete. In general, using such devices wastes resources and results in expensive downtime for the overall process.

### SUMMARY OF THE DISCLOSURE

The present disclosure provides a filtration device that solves the aforementioned problems in the prior art. The filtration device constructed in accordance with the present disclosure includes a filter housing sump for seating a replaceable filter media pack therein, a filter head assembly and a fastening assembly which facilitates easier removal for filter media pack replacement. Preferably, the fastening assembly is operable by hand without requiring a separate tool.

In one embodiment, the filtration device of the present disclosure includes a filter sump assembly, a filter head and fastening assembly that incorporates an independent clamping device. The clamping assembly includes a pair of arms that are configured and dimensioned to encompass the seal between the filter head assembly and filter housing sump. When engaged on the filtration device, the arms apply substantially the same force along the entire seal. The arms are pivotally connected to each other by a hinge at one end of each respective arm. The other end of each arm includes projecting tongues for facilitating affixing a fastening device thereto.

In another embodiment of the present disclosure, the filter head assembly further includes connectors for the fluid inlet and outlet lines which are configured to allow the filter head assembly to stay online when the filter housing sump is detached. Preferably, these connectors include what is commonly referred to as “O-ring” type connectors.

In yet another embodiment of the present disclosure, the filter head further includes a lever and piston assembly for applying pressure to the filter media pack to force the filter media pack from any attachment that it may have had with the filter head. The lever is pivotally mounted on the filter head and operatively associated with the piston. The piston is mounted for slidable movement so that it extends from the exterior of the filter head to the interior of the filter housing to contact the filter media pack seated therein. The lever and piston assembly is configured to cooperate so that the force is translated to the piston by the lever at a location closer to the pivotal mounting of the lever than its opposing free end.

In still yet another embodiment of the present disclosure, the filter housing system comprises: a filter housing sump having a central cavity and an axial opening for providing access to the central cavity, the central cavity being configured and dimensioned for receiving and seating a filter media pack therein; a filter housing head assembly configured and dimensioned to fit on the filter housing sump such that axial opening is covered thereby; a clamping device for sealing the filter media pack between the filter head and the filter housing sump, the clamping device comprising: at least two curved members, each curved member having two ends; at least one hinge assembly, the at least two curved members being operatively pivotally attached to each other at one end by the at least one hinge assembly; at least two tongue members, operatively positioned at the second end of the at least two curved members; and at least one fastening device, the at least one fastening device being operative to force the at least two tongues members together such that an operator can generate sufficient torque to effectuate the seal therebetween, for facilitating the installation of the filter media pack in the filter housing sump.

In another embodiment of the present disclosure, the filter housing assembly comprising: a filter housing sump having a central cavity and an axial opening for providing access to the central cavity, the central cavity being configured and dimensioned for receiving and seating a filter media pack therein; a filter housing head assembly configured and dimensioned to fit on the filter housing sump such that axial opening is covered thereby; a clamping device for operatively positioning the filter head relative to the filter housing sump when the filter media pack is operatively positioned therein, the clamping device comprising: at least two curved members, each curved member having two ends; at least one hinge assembly, the at least two curved members being operatively pivotally attached to each other at one end by the at least one hinge assembly; at least two tongue members, operatively positioned at the second end of the at least two curved members; and at least one fastening device, the at least one fastening device being operative to force the at least two tongues members together such that an operator can generate sufficient torque to effectuate the seal between the filter media pack, the filter housing sump and the filter housing head assembly, for facilitating the installation of the filter media pack in the filter housing sump.

Other objects and advantages of the present disclosure will be apparent from the following description, and the accompanying drawings.

### BRIEF DESCRIPTION OF THE DRAWINGS

So that those having ordinary skill in the art to which the subject disclosure pertains will more readily understand how to make and use the filtration assembly of the subject disclosure, preferred embodiments thereof will be described in detail hereinbelow with reference to the drawings, wherein:

FIG. 1 is a top plan view of a filter housing assembly constructed in accordance with one representative embodiment of the subject disclosure;

FIG. 2 is a cross-sectional view of the filter housing assembly of the subject disclosure taken along line 2-2 of FIG. 1;

FIG. 3 is an isometric view of one representative embodiment of an inlet or outlet connector which may be used with a filtration assembly constructed in accordance with the subject disclosure;

FIG. 4 is a side elevational view of the connector shown in FIG. 3;

FIG. 5 is a top plan view of the connector shown in FIG. 3;

FIG. 6 is a cross-sectional view of the connector of the subject disclosure taken along line 6-6 of FIG. 5;

FIG. 7 is a close-up view of the connector of the subject disclosure taken from detail 7 in FIG. 6;

FIG. 8 is a cross-sectional view of the filter head assembly constructed in accordance with the subject disclosure taken along line 3-3 of FIG. 1, wherein the lever is in a position which does not force the piston into the filter head;

FIG. 9 a cross-sectional view of the filter head constructed in accordance with the subject disclosure taken along line 3-3 of FIG. 1, wherein the lever is in a position which would force the piston into the filter head;

FIG. 10 is a top plan view of a another representative filter housing assembly constructed in accordance with one representative embodiment of the subject disclosure;

FIG. 11 is a cross-sectional view of the filter housing assembly of the subject disclosure taken along line 2-2 of FIG. 10;

FIG. 12 is a cross-sectional view of the filter head assembly constructed in accordance with the subject disclosure taken along line 2-2 of FIG. 10, wherein the filter head has a two-piece construction;

FIG. 13 is a cross-sectional view of the filter head constructed in accordance with the subject disclosure taken along line 2-2 of FIG. 10, wherein the filter head has a unitary construction;

FIG. 14 is a partial cross-sectional view of the an alternate embodiment of the filter housing assembly of the subject disclosure taken along line 2-2 of FIG. 10;

FIG. 15 is a top plan view of the filter housing assembly constructed in accordance with another representative embodiment of the subject disclosure; and

FIG. 16 is a perspective view of the knob of FIG. 15.

### ENABLING DESCRIPTION OF THE DISCLOSURE

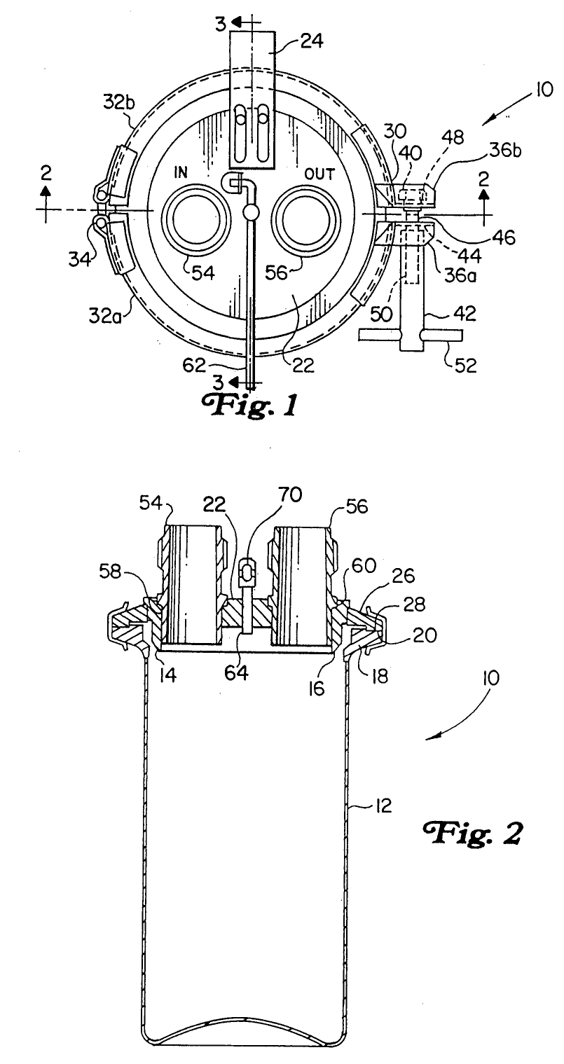

Referring now to the drawings, FIGS. 1 and 2 illustrate a representative filter housing assembly 10 of generally tubular shape and defining a longitudinal axis which will be used in the following description as a reference. Filter housing assembly 10 includes an elongate filter housing sump 12 having an axial opening 14 which provides access to a central cavity 16 in housing sump 12. Cavity 16 is configured and dimensioned for receiving and seating a filter media pack (not shown) therein, which may be of any size or type depending on the desired treatment and flow rate. A radial body flange rim 18 surrounds the housing sump 12 adjacent to opening 14 and has a substantially planar surface portion 20 defined along its periphery.

Assembly 10 further includes a generally disc-shaped filter head assembly 22 which is configured and dimensioned to fit on housing sump 12 so that it covers opening 14. Filter head assembly 22 includes, in one representative embodiment, a bracket 24 which may be used to secure the clamp 30 to the filter head assembly 22, a radial flange rim 26 which is configured and dimensioned to abut radial body flange rim 18 when filter head assembly 22 is put in position on housing sump 12. Radial flange rim 26 has a substantially planar surface portion 28 defined along its periphery which contacts the planar surface portion 20 on radial body flange rim 18 when filter head assembly 22 is fit onto housing sump 12.

As illustrated in FIGS. 1, 2, 10, 11, 14 and 15, a representative self-supporting, independent clamping device 30 is used to seal filter head assembly 22 to filter housing sump 12. Clamping device 30 includes, but is not limited to, a pair of curved arms 32a and 32b which are pivotally attached to each other at one end by a hinge assembly 34. The other respective ends of each arm 32a and 32b include tongues 36a and 36b for facilitating the installation of a fastening device to force tongues 36a and 36b together. In this representative embodiment, tongues 36a and 36b have bores or slots 44 therein for receiving male and female fasteners 40 and 42, and cooperating therewith to secure the clamping device 30. Arms 32a and 32b are configured and dimensioned to engage both radial flange rim 26 and radial body flange rim 18 when a filter media pack is installed therein and filter head assembly 22 is positioned onto filter housing sump 12 in a manner which distributes the compression load evenly around the entire seal, axially and radially, when clamping device 30 is engaged. Presently preferably, arms 32a and 32b are shaped to correspond with the profile created by the rims 26 and 18.

In the illustrated representative embodiments, one possible representative male fastener 40 is essentially a threaded eye bolt, having a threaded rod portion 46 of sufficient length and a round flat head 48, the portion 46 being of a smaller diameter than the bore or slot in tongue 36a. One possible representative female fastener 42 includes a threaded bore 50 for engaging the threaded rod portion 46 of male fastener 40 and a knob 52, which is presently preferably shaped such that an operator can generate sufficient torque to effectuate the seal therebetween when a filter media pack is operatively positioned in the filter housing assembly 10, for facilitating the rotational motion necessary to secure the fasteners 40, 42 to each other.

In normal usage, filter head assembly 22 must be fit and sealed onto housing sump 12 with a filter media pack properly seated therein, prior to introducing any fluid flow into the filter housing assembly 10. Untreated fluid enters the filter housing assembly 10 through an inlet conduit 54 and the treated fluid exits filter assembly 10 through a fluid outlet conduit 56. Inlet and outlet conduits 54 and 56 are disposed in axial bores 58 and 60, respectively, which extend into housing sump 12 through filter head assembly 22.

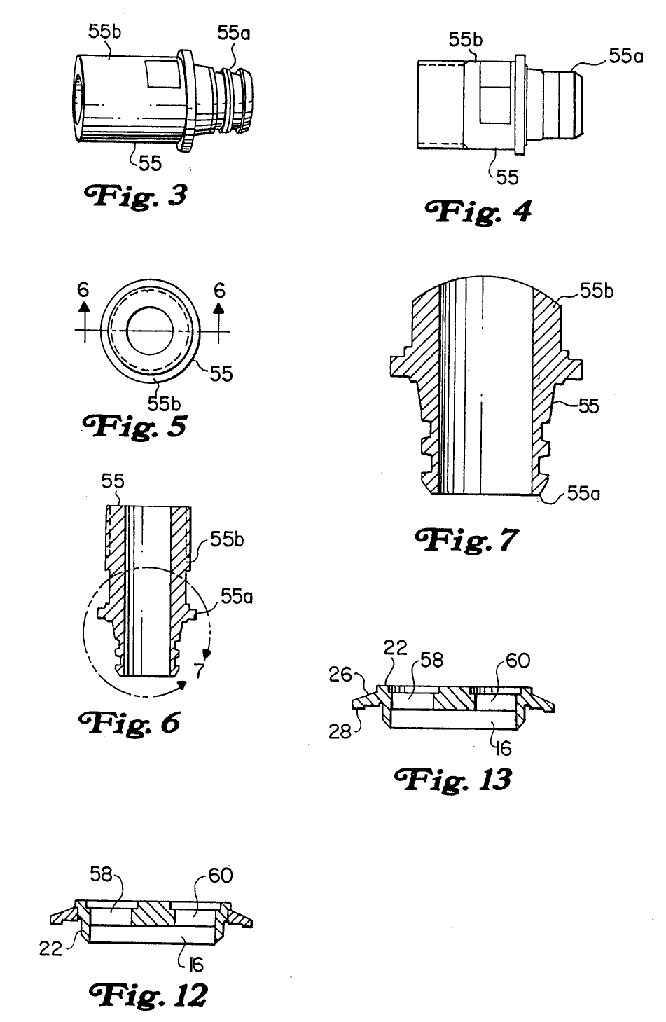

FIGS. 3-7 illustrate one possible representative embodiment of connecting components that connect the inlet and outlet conduits 54 and 56 to the fluid supply and the effluent product of the filtration. These components may include a plurality of tubular fittings, fasteners and rubber O-rings or metal washers. In the illustrated representative embodiment, a pair of O-ring type fittings of different size, along with cone nuts and cone connectors and wave springs are used to operatively attach inlet source an the outlet to portions of conduits 54, 56. These connectors, referred to as connector 55 in FIGS. 3-7, include a tapered threaded portion 55b operatively connected with a dual O-ring portion 55a. A pair of connectors 55 are used to create a tight seal between the filter media pack and conduits 54, 56, the outside fluid supply (not shown) and fluid receiving conduit (not shown) and also allow filter housing sump 12 to be opened for a filter media pack change or maintenance without taking the filter head assembly 22 offline.

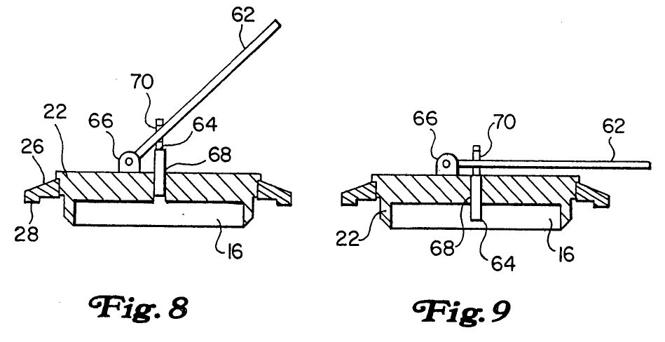

As shown in FIGS. 1-2, and in particular FIGS. 8-9, the representative embodiment depicted herein advantageously includes an elongate lever 62 and piston 64 which are configured to facilitate detachment of the filter head assembly 22 from the filter housing sump 12 and filter media pack operatively positioned therein. Lever 62 is mounted for pivotal movement about a 180 degree arc relative to filter head assembly 22 by coupling 66 disposed on the upper surface of filter head assembly 22. Piston 64 is disposed in an axial bore 68 in filter head assembly 22 and slidably mounted for axial movement therethrough so that at one amplitude of movement a first end of the piston 64 extends into cavity 16.

As can be best viewed in FIGS. 8 and 9, piston 64 includes a socket 70 at its second and opposing end for receiving lever 62. Thus, lever 62 and piston 64 are operatively associated with each other so that a force applied to move the lever 62 in a generally axial direction towards filter head assembly 22 is translated to piston 64 through its connection with lever 62 at socket 70. As a result, piston 64 moves axially into cavity 16 and pushes the filter media pack therein away from the lower surface of filter head assembly 22. Preferably, the positioning of piston 64 relative to lever 62 (i.e., the point at which force is translated from the lever 62 to the piston 64) optimizes the balance between leverage and inertia. In this representative embodiment, the point of connection, that is, socket 70, is approximately one third of the length of lever 62.

The above described mechanism achieves the desired improved operator friendly construction which allows an operator to change out the filter media pack, such as, for example, a Cartridge Klean pack, by hand quickly and easily by him or herself, without assistance. Specific innovations that were developed include:

(1) A self supported clamp operatively connected to the housing head to allow the operator to operatively connect the clamp using only one hand.

(2) An O-ring type connector was utilized on the inlet and outlet conduits so that the head component remained on line during the filter media pack change out.

(3) Use of the O-ring type connector facilitated the quick and easy change out of the filter media pack.

(4) The used filter media pack can then be easily released from the head component by use of the push rod positioned on the head component with the operator using only one hand.

(5) The total operating time to accomplish the system change over is most likely significantly reduced from about 5 minutes to less than about 1 minute and is accomplished by an operator that does not need to possess a high skill level or to receive any specific equipment operation training.

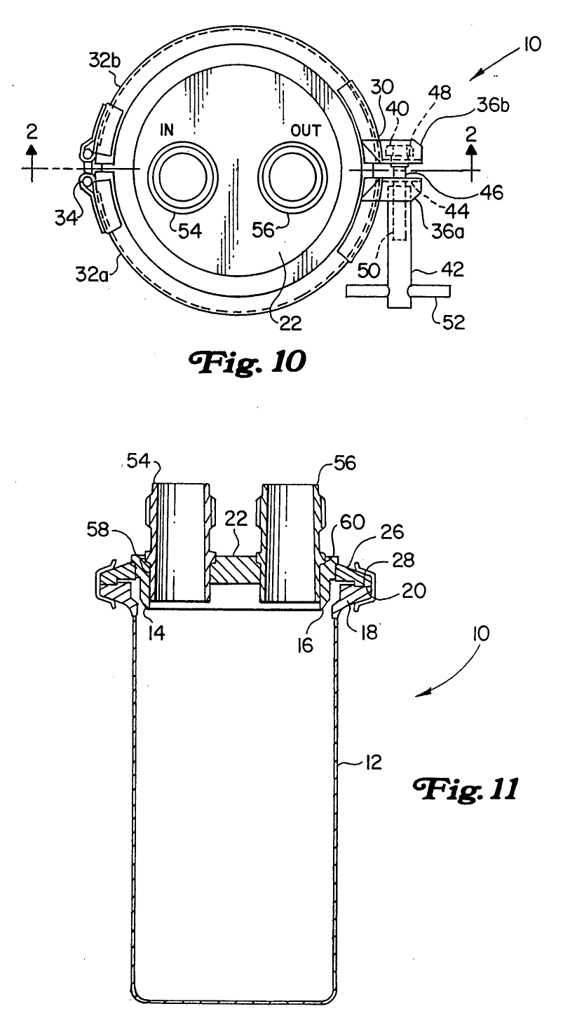

Another representative embodiment is illustrated in FIGS. 10-11 and illustrates another possible representative embodiment of the present disclosure but without the means for facilitating detachment of the filter head assembly 22 from the filter housing sump 12 and filter media pack operatively positioned therein, such as the bracket 24 or the lever 62 and piston 64. This particular embodiment can be used in applications where the means for facilitating the detachment of the various components to effectuate filter media pack change out is not believed to be particularly advantageous.

FIGS. 12-13 illustrate alternate embodiment of filter head assembly 22. These figures illustrate that the filter head assembly 22 component including the axial bores 58 and 60 may be a unitary piece or a multiple component piece with the axial bores 58 and 60 being press fitted therein or otherwise conventionally operatively attached thereto.

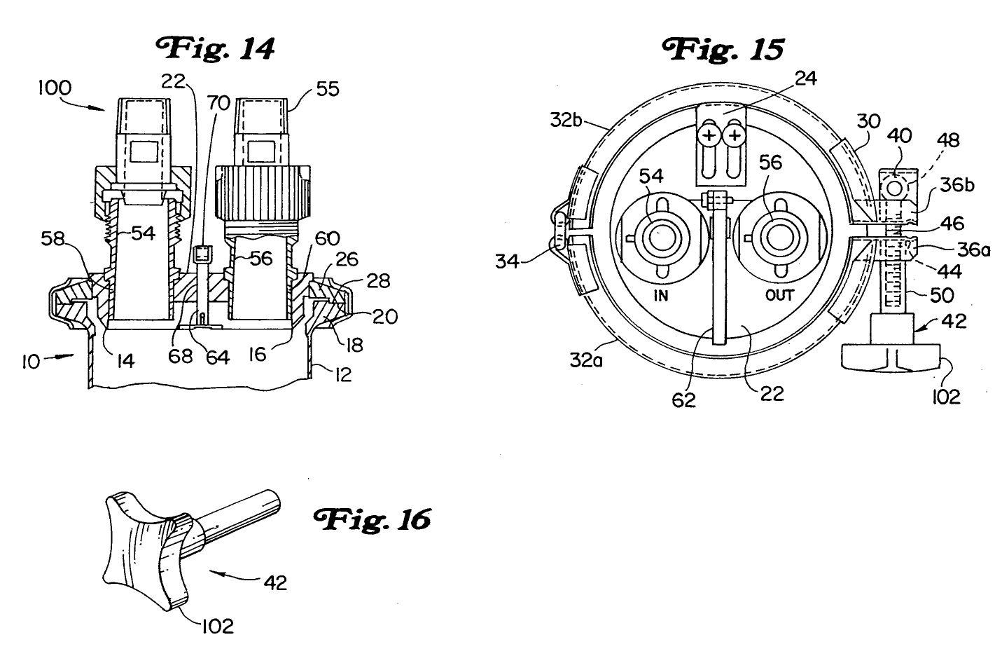

FIGS. 14-16 illustrate still another possible embodiment according to the present disclosure. FIGS. 14-15 are similar to FIGS. 1-2 except that these figures illustrate another possible alternative embodiment for the means for facilitating the detachment of the various components to effectuate filter media pack change out. FIG. 14 illustrates the components of FIGS. 3-7 assembled to the filter head assembly 22 via the axial bores 58 and 60 at 100. The details of the alternative representative embodiment illustrated in FIGS. 14-16 are not described in detail, as applicants believe that a person of ordinary skill in the art would readily appreciate these details from the illustrations provided as well as appreciating that numerous other possible combinations of specific components could be utilized to perform the functions required to accomplish the desired results, as described in detail above.

FIG. 16 illustrates a representative knob that has been found to be more effective to generate the requisite force necessary to effectively seal the filter media pack in position during operations. Specifically, the representative knob as illustrated that has proven adequate for this task includes protrusions 102 extending from the knob 42, as shown in FIGS. 15 and 16. This particular shaped knob allows an operator to more easily grip the knob and to tighten the fasteners together thereby effectuating the necessary force to seal the filter media pack between the filter head assembly 22 and the housing sump 12.

As can be seen from the above, applicants have provided a new and innovative filtration device for replaceable filter media that provides for the easy change out of a filter media pack, in one embodiment such that an operator can easily perform the task without additional tools or specific training related thereto. Further, applicants have provided a means for facilitating the detachment of the various components to effectuate filter media pack change out and/or a particular shaped knob which allows an operator to more easily grip the knob and to tighten the fasteners together thereby effectuating the necessary force to seal the filter media pack between the filter head assembly 22 and the housing sump 12.

Although the filter housing assembly of the subject disclosure has been described with respect to presently preferred embodiments, those skilled in the art will readily appreciate that changes and modifications may be made thereto without departing from the spirit and scope of the present disclosure.

What is claimed is:

1. A filter housing system comprising:
a) a filter housing sump having a central cavity and an axial opening having a surface for providing access to the central cavity, the central cavity being configured and dimensioned for receiving and seating a filter media pack therein;
b) a filter housing head assembly having a surface and a bracket, the surface of the filter housing head assembly being configured and dimensioned to operatively interface with the axial opening surface of the filter housing sump such that the axial opening is covered thereby;
c) a clamping device for sealing the filter media pack between the filter housing head assembly and the filter housing sump, the clamping device comprising:
i) at least two curved members, each curved member having first and second ends;
ii) at least one hinge assembly, the at least two curved members being operatively pivotally attached to each other at the first end by the at least one hinge assembly;
iii) at least two tongue members operatively positioned at the second end of the at least two curved members; and
iv) at least one fastening device, the at least one fastening device being operative to force the at least two tongue members to form a seal
d) wherein the bracket secures the clamping device to the filter housing head assembly; and
e) structure for operatively disengaging the filter housing head assembly from the filter housing sump such that the surface of the axial opening of the filter housing sump and the surface of the filter housing head assembly are readily separated one from the other.

2. The filter housing system of claim 1 wherein a radial body flange surrounds the filter housing sump adjacent to the axial opening and has a substantially planar surface portion defined along its periphery.

3. The filter housing system of claim 2 wherein the filter housing head assembly further comprises:
a radial flange configured and dimensioned to abut the radial body flange rim of the filter housing sump when the filter housing head assembly is operatively positioned on the filter housing sump, the radial flange having a substantially planar surface portion defined along its periphery for operatively contacting the planar surface portion of the radial body flange rim when the filter housing head assembly is operatively positioned onto the filter housing sump.

4. The filter housing system of claim 2 wherein the at least two curved members are configured and dimensioned to engage both the radial body flange and the radial flange when a filter media pack is installed therein and the filter housing head assembly is operatively positioned on the filter housing sump such that a compression load is distributed evenly around the entire periphery of the radial body flange and the radial flange when the clamping device is operatively engaged.

5. The filter housing system of claim 3 wherein the at least two curved members are shaped to correspond with the profile created by the radial body flange and the radial flange.

6. The filter housing system of claim 5 wherein the at least one fastening device further comprises:
a female fastener and a male fastener, the male fastener comprising:
a threaded eye bolt, having a threaded rod portion of sufficient length for operatively engaging the at least two tongue members and a round flat head.

7. The filter housing system of claim 6 wherein the round flat head has a smaller diameter than a bore in the at least two tongue members.

8. The filter housing system of claim 6 wherein the female fastener further comprises:
a threaded bore for engaging the threaded rod portion of the male fastener; and
a knob having at least two protrusions, for facilitating the rotational motion necessary to secure the male and female fasteners to each other.

9. The filter housing system of claim 8 wherein the knob further comprises:
three or more protrusions, operatively extending from the knob, for facilitating grip of the knob and to tighten the male and female fasteners together thereby effectuating the seal between the two curved members.

10. The filter housing system of claim 1 wherein the filter housing head assembly further comprises:
a lever and piston assembly adapted to apply pressure to a filter media pack to force the filter media pack from any attachment that it may have had with the filter housing head assembly.

11. The filter housing system of claim 10 wherein the lever is pivotally mounted on the filter housing head assembly and operatively associated with the piston.

12. The filter housing system of claim 10 wherein the piston is mounted for slidable movement so that it is capable of extending from the exterior of the filter housing head assembly to the interior of the filter housing sump.

13. The filter housing system of claim 10 wherein the lever and piston assembly is configured to cooperate so that the force is translated to the piston by the lever.

14. A filter housing assembly comprising:
a) a filter housing sump having a central cavity and an axial opening for providing access to the central cavity, the central cavity being configured and dimensioned for receiving and seating a filter media pack therein;
b) a filter housing head assembly including a bracket and a lever and piston assembly adapted for applying pressure to the filter media pack to force the filter media pack from any attachment that it may have had with the filter housing head assembly, wherein the lever is pivotally mounted on the filter housing head assembly and operatively associated with the piston and has a free end, the filter housing head assembly being configured and dimensioned to operatively interface with the filter housing sump such that axial opening is covered thereby, the interface between the filter housing sump and the filter housing head assembly comprising at least one complimentary surface operatively positioned on each respectively;
c) a clamping device for operatively positioning the filter housing head assembly relative to the filter housing sump when the filter media pack is operatively positioned therein, the clamping device comprising:
i) at least two curved members, each curved member having first and second ends;
ii) at least one hinge assembly, the at least two curved members being operatively pivotally attached to each other at the first end by the at least one hinge assembly;
iii) at least two tongue members, operatively positioned at the second end of the at least two curved members; and
iv) at least one fastening device, the at least one fastening device being operative to force the at least two tongue members together to form a seal therebetween;
d) wherein the bracket secures the clamping device to the filter housing head assembly; and
e) structure for operatively disengaging the filter housing head assembly from the filter housing sump such that the surface of the filter housing sump and the surface of the filter housing head assembly are separated one from the other.

15. The filter housing assembly of claim 14 wherein a radial body flange surrounds the filter housing sump adjacent to the axial opening and has a substantially planar surface portion defined along its periphery.

16. The filter housing assembly of claim 15 wherein the filter housing head assembly further comprises:
a radial flange configured and dimensioned to abut the radial body flange of the filter housing sump when the filter housing head assembly is operatively positioned on the filter housing sump, the radial flange having a substantially planar surface portion defined along its periphery for operatively contacting the planar surface portion of the radial body flange when the filter housing head assembly is operatively positioned onto the filter housing sump.

17. The filter housing assembly of claim 15 wherein the at least two curved members are configured and dimensioned to engage both the radial body flange and the radial flange when a filter media pack is installed therein and the filter head is operatively positioned on the filter housing sump such that a compression load is distributed evenly around the entire periphery of the radial body flange and the radial flange when the clamping device is operatively engaged.

18. The filter housing assembly of claim 15 wherein the at least two curved members are shaped to correspond with the profile created by the radial body flange and the radial flange.

19. The filter housing assembly of claim 17 further comprising a female and a male fastener, the male fastener comprising:
a threaded eye bolt, having a threaded rod portion of sufficient length for operatively engaging the at least two tongue members and a round flat head.

20. The filter housing assembly of claim 19 wherein the round flat head has a smaller diameter than a bore in the at least two tongue members.

21. The filter housing assembly of claim 19 wherein the female fastener further comprises:
a threaded bore for engaging the threaded rod portion of the male fastener; and
a knob having at least two protrusions, for facilitating the rotational motion necessary to secure the male and female fasteners to each other.

22. The filter housing assembly of claim 21 wherein the knob further comprises:
three or more protrusions operatively extending from the knob, for facilitating grip of the knob and to tighten the male and female fasteners together, thereby effectuating the seal between the at least two curved members.

23. The filter housing assembly of claim 14 wherein the piston is mounted for slidable movement so that it extends from the exterior of the filter housing head assembly to the interior of the filter housing head assembly to contact the filter media seated therein.

24. The filter housing assembly of claim 14 wherein the lever and piston assembly is configured to cooperate so that the force is translated to the piston by the lever at a location closer to the pivotal mounting of the lever than the lever free end.
